(19) United States
(12) Patent Application Publication
(10) Pub. No.: US 2010/0033398 A1
(43) Pub. Date: Feb. 11, 2010

(54) MODULAR ACTIVE ANTENNA FOR RECEIVING MULTIPLE BROADCASTING SIGNALS

(75) Inventors: Jong-Ho JUNG, Yongin (KR); Byong-Nam KIM, Bucheon (KR); Young-Bok LEE, Bucheon (KR)

Correspondence Address: LRK Patent Firm, 1952 Gallows Rd Suite 200, Vienna, VA, 22182, US

(73) Assignee: ACE ANTENNA CORP., Incheon (KR)

(21) Appl. No.: 12/538,017

(22) Filed: Aug. 7, 2009

(30) Foreign Application Priority Data
Aug. 11, 2008 (KR) 10-2008-0078370

(51) Int. Cl. H01Q 1/38; H01Q 1/50; H01Q 5/00

(52) U.S. Cl. 343/860; 343/700 MS

(57) ABSTRACT

The present invention relates to a modular active antenna for receiving multiple broadcast signals. The modular active antenna includes an internal antenna, an active module and a printed circuit board. The internal antenna is formed in a polyhedral shape having an open bottom surface and configured to receive multiple broadcast frequency signals. The active module is arranged below the internal antenna to constitute a single module together with the internal antenna and is configured to selectively perform impedance matching on any one of the multiple broadcast frequency signals received by the internal antenna. The printed circuit board is configured to allow the internal antenna and the active module to be mounted thereon and is provided with a ground surface formed on the bottom thereof.

Therefore, the present invention is advantageous in that it can receive multiple broadcast frequency signals through a single active antenna.

### BACKGROUND OF THE INVENTION

1. Field of the Invention

The present invention relates, in general, to a modular active antenna for receiving multiple broadcast signals, and, more particularly, to a modular active antenna for receiving 1o multiple broadcast signals, in which an active module for selectively performing impedance matching on any one of multiple received broadcast frequency s-.gnals is arranged below an internal antenna for receiving the multiple broadcast frequency signals, thus enabling the internal antenna and the active module to be implemented as a single block-shaped module.

2. Description of the Related Art

Currently, mobile terminals not only provide digital broadcasting services such as Digital Multimedia Broadcasting (DMB) using Very-High Frequency (VHF) and Ultra-High Frequency (UHF) bands, but also collectively have a variety of service functions such as Bluetooth and Global Positioning System (GPS) services.

FIG. 1 illustrates one example of a conventional active antenna structure.

As shown in FIG. 1, a conventional active antenna includes an external antenna 1 having a specific shape, such as an external rod antenna or a detachable antenna, and an active module 2 for performing impedance matching on single band broadcast signals received by the external antenna 1.

However, such a conventional active antenna is problematic in that, since it is used only in a single band, it is difficult to apply the active antenna to multiple bands. Further, the latest terminals collectively provide a variety of application services such as mobile communication service, Frequency Modulation (FM) radio service, and digital broadcasting service (Terrestrial-DMB [T-DMB] and Digital Video Broadcasting-Handheld [DVB-H]). Furthermore, due to the trend towards terminals having a small size, a spatial problem attributable to the arrangement of an antenna in a terminal for a variety of application services also occurs. In particular, since FM radio broadcasting service and digital broadcasting service have a low usable frequency band, the size of antennas inevitably increases to satisfy electrical performance, and thus the implementation of separate antennas for respective broadcasting services makes it difficult to provide a small terminal.

Furthermore, such a conventional active antenna is disadvantageous in that, since it includes an external antenna for receiving broadcast signals and an active module, the design of terminals is limited so it is difficult to apply the antenna to a small mobile communication terminal, and the risk of damage attributable to an external impact is present.

### SUMMARY OF THE INVENTION

Accordingly, the present invention has been made keeping in mind the above problems occurring in the prior art, and an object of the present invention is to provide a modular active antenna for receiving multiple broadcast signals, which includes a single internal antenna for receiving multiple broadcast frequency signals and, a single active module for selectively performing impedance matching on any one of the multiple broadcast frequency signals, and in which the active module is arranged below the single internal antenna, thus enabling the internal antenna and the active module to be implemented as a block-shaped module.

In order to accomplish the above object, the present invention provides a modular active antenna for receiving multiple broadcast signals, comprising an internal antenna formed in a polyhedral shape having an open bottom surface and configured to receive multiple broadcast frequency signals, an active module arranged below the internal antenna to constitute a single module together with the internal antenna and configured to selectively perform impedance matching on any one of the multiple broadcast frequency signals received by the internal antenna, and a printed circuit board configured to allow the internal antenna and the active module to be mounted thereon and provided with a ground surface formed on the bottom thereof.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing an example of a conventional active antenna structure;

FIG. 2 is a perspective view of a modular active antenna for receiving multiple broadcast signals according to the present invention;

FIG. 3A is a top view of the modular active antenna for receiving multiple broadcast signals according to the present invention;

FIG. 3B is a sectional view of the modular active antenna for receiving multiple broadcast signals according to the present invention;

FIG. 3C is a top view showing the structure of the input part and output part of the active module of the modular active antenna for receiving multiple broadcast signals according to the present invention;

FIG. 4 is a diagram showing an embodiment of the active module of the modular active antenna for receiving multiple broadcast signals according to the present invention;

FIG. 5A is a graph showing FM radio signals before passing through an active module after being received by a single internal antenna according to the present invention;

FIG,. 5B is a graph showing FM radio signals after being received by a single internal antenna and passing through an active module according to the present invention;

FIG. 5C is a graph showing the gain properties of a DVB-H signal having passed through an active module according to the present invention; and

FIG. 6 is a diagram showing another embodiment of the active module of a modular active antenna for receiving multiple broadcast signals according to the present invention.

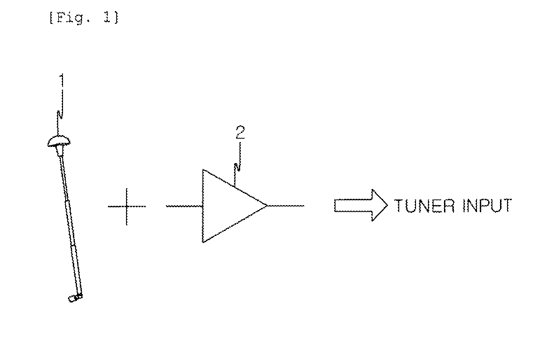

### DESCRIPTION OF THE PREFERRED EMBODIMENTS

Hereinafter, embodiments of the present invention will be described in detail with reference to the attached drawings.

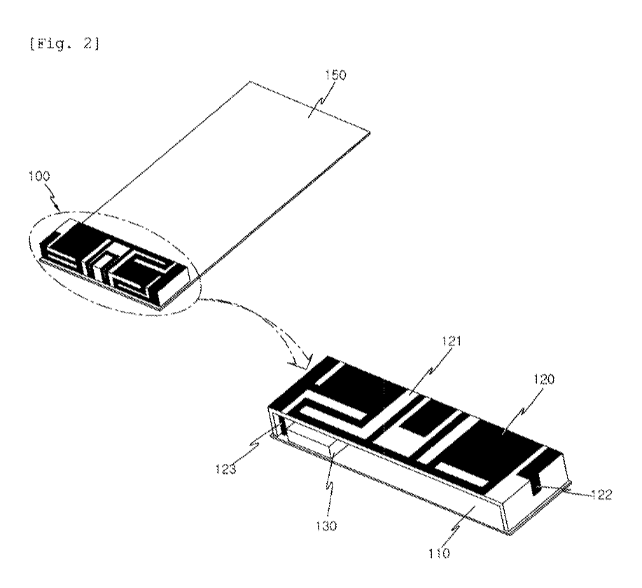

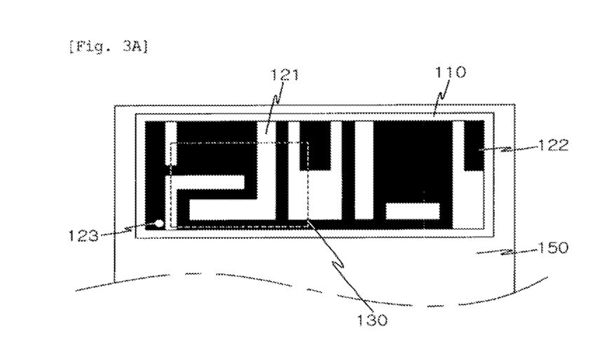

FIG. 2 is a perspective view of a modular active antenna for receiving multiple broadcast signal's according to the present invention. As shown in FIG. 2, a modular active antenna 100 for receiving multiple broadcast signals according to the present invention is mounted on the main board 150 of a terminal.

The modular active antenna 100 for receiving multiple broadcast signals according to the present invention includes an internal antenna 120, an active module 130, and a Printed Circuit Board (PCB) 110. The internal antenna 120 is formed in a polyhedral shape having an open bottom surface and is configured to receive multiple broadcast frequency signals. The active module 130 is arranged below the internal antenna 120 to constitute a single module together with the internal antenna 120 and is configured to selectively perform impedance matching on any one of the multiple broadcast frequency signals received by the internal antenna 120. The PCB 110 is configured to allow the internal antenna 120 and the active module 130 to be mounted thereon and is provided with a ground surface formed on the bottom thereof.

The internal antenna 120 includes a frame 121 formed in a polyhedral shape in which, of a plurality of surfaces thereof, at least the bottom surface is open; a radiating element 122 formed on the surface of the frame 121 in a plurality of patterns for receiving the multiple broadcast frequency signals; and a feed pin 123 configured to connect the radiating element 122 to the active module 130 which is arranged below the frame 121 and spaced apart from the frame 121 by a predetermined distance.

As shown in FIG. 2, the frame 121 may have a polyhedral shape in which side surfaces adjacent to the bottom surface, as well as the bottom surface, are open.

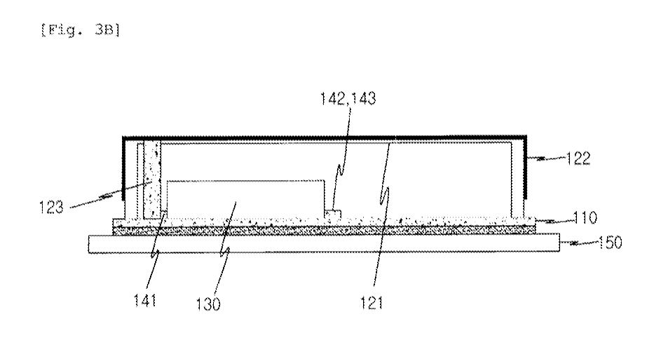

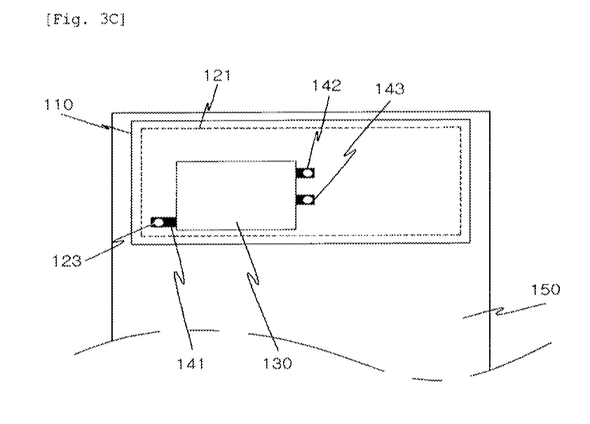

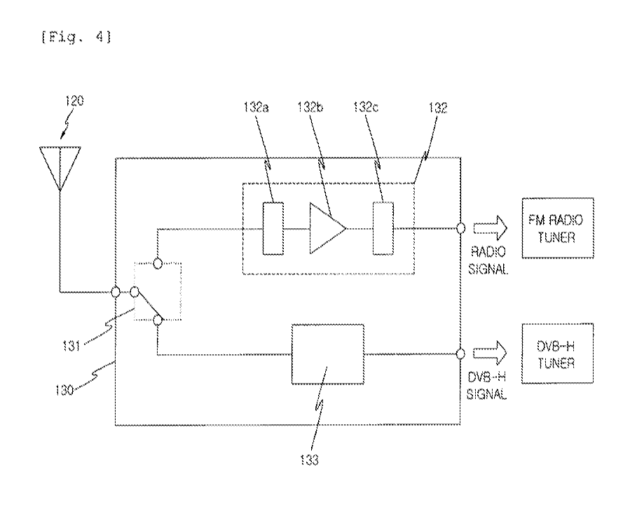

FIG. 3A is a top view of the modular active antenna for receiving multiple broadcast signals of FIG. 2 according to the present invention, FIG. 3B is a sectional view of the modular active antenna for receiving :-multiple broadcast signals according to the present invention, and FIG. 3C is a top view of the structure of the input part and output part of the active module 130 of the modular active antenna for receiving multiple broadcast signals according to the present invention.

As shown in FIGS. 3A to 3C, the active module 130 is arranged below the internal antenna 120 formed as a polyhedral frame in which, of a plurality of the surfaces thereof, at least the bottom surface is open, and is configured to constitute a single block-shaped module together with the internal antenna 120. The internal antenna 120 and the active module 130 are mounted on the PCB 110. The internal antenna 120 and the active module 130 are formed as one module, thus improving the availability of mounting space within the terminal.

The feed pin 123 of the internal antenna 120 is configured such that one end thereof is connected to the radiating element 122 formed on the surface of the frame 121 via a through hole, formed at a predetermined location of the frame 121, and the other end is connected to the PCB 110 in order to connect the radiating element 122 to the active module 130. As shown in FIG. 3C, the other end of the feed pin 123 is connected to the active module 130 through an input line 141 arranged on the PCB 110. The input line 141 is implemented as, for example, a microstrip line.

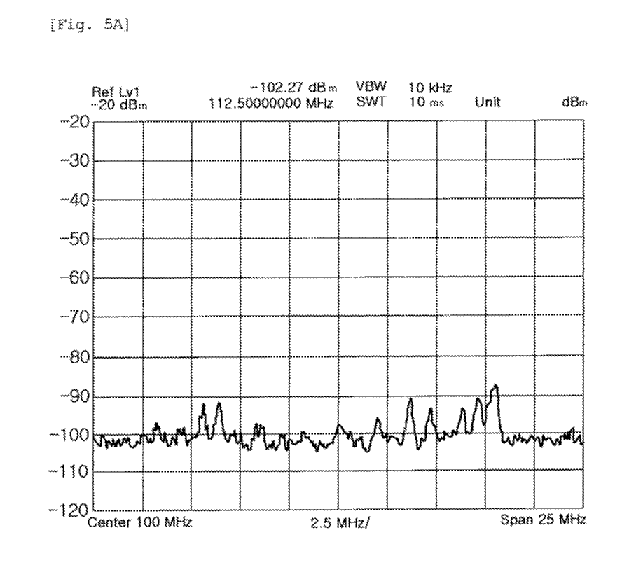

FIG. 4 is a diagram showing an embodiment of the active module of the modular active antenna for receiving multiple broadcast signals according to the present invention.

The embodiment of the active module according to the present invention includes a switching unit 131, a first impedance matching unit 132, and a second impedance matching unit 133. The switching unit 131 selectively performs switching in response to a switching control signal so that a path for any one of the multiple broadcast frequency signals received by the internal antenna 120 is established. The first impedance matching unit 132 performs impedance matching on a first broadcast frequency signal among the multiple broadcast frequency signals switched by the switching unit 131 and outputs the impedance-matched signal to a first tuner. The second impedance matching unit 133 performs impedance matching on a second broadcast frequency signal among the multiple broadcast frequency signals switched by the switching unit 131 and outputs the impedance-matched signal to a second tuner.

The switching control signal is output: from the terminal control unit.

The first impedance matching unit 132 includes an input matching unit 132a, a low-noise amplifier 132b and an output matching unit 132c. The input matching unit 132a performs input impedance matching on the first broadcast frequency signal switched by the switching unit 1;1. The low-noise amplifier 132b eliminates noise from the first broadcast frequency signal impedance-matched by the input matching unit 132a and amplifies the noise-free first broadcast frequency signal. The output matching unit 132c performs output impedance matching on the first broadcast frequency signal amplified by the low-noise amplifier 132b and outputs the impedance-matched first broadcast frequency signal to the first tuner.

For example, the first broadcast frequency signal is a Frequency Modulation (FM) radio signal and the second broadcast frequency signal is a Digital Video Broadcasting-Handheld (DVB-H) signal. In this case, the low-noise amplifier 132b of the first impedance matching unit 132 is configured to amplify low-noise in the FM radio signal, and the second impedance matching unit 133 is configured to perform impedance matching on the DVB-H signal.

The operation of the modular active antenna for receiving multiple broadcast signals according to the present invention, including the active module 130 constructed as described above, will be described below.

First, the internal antenna 120 receives multiple broadcast frequency signals and transmits the received multiple broadcast frequency signals to the active module 130 through the feed pin 123.

When the user of the terminal desires to listen to FM radio, a switching control signal is output from the terminal control unit, and the switching unit 131 of the active module 130 is operated in response to the output: switching control signal. Accordingly, the switching unit 131 is connected to the first impedance matching unit 132, and the second impedance matching unit 133 is open and disconnected from the switching unit 131. Therefore, the multiple broadcast frequency signals received from the internal antenna 120 are applied to the first impedance matching unit 132 through the switching unit 131.

Then, the first impedance matching unit 132 performs impedance matching on an FM radio signal among the applied multiple broadcast frequency signals, eliminates noise from the impedance-matched FM radio signal, amplifies the noise-free FM radio signal, and outputs the -amplified FM radio signal to a first output pin 142. The FM radio signal output to the first output pin 142 is provided to the main board of the terminal through the PCB 110 and is then transmitted to an FM radio tuner which is the first tuner.

Meanwhile, when the user of the terminal desires to view a DVB-H signal, a switching control signal is output from the terminal control unit, and the switching unit 131 of the active module 130 is operated in response to the output switching control signal. Accordingly, the switching unit 131 is connected to the second impedance matching unit 133, and the first impedance matching unit 132 is open and disconnected from the switching unit 131. Therefore, the multiple broadcast frequency signals received from the internal antenna 120 are applied to the second impedance matching unit 133 through the switching unit 131.

Then, the second impedance matching unit 133 performs impedance matching on a DVB-H signal among the applied multiple broadcast frequency signals and outputs the impedance-matched DVB-H signal to a second output pin 143. The DVB-H signal output to the first output pin 143 is provided to the main board of the terminal through the PCB 130 and is then transmitted to a DVB-H tuner which is the second tuner.

According to the present invention, the internal antenna receives the multiple broadcast frequency signals, and the active module selects a relevant broadcast frequency signal from among the received multiple broadcast frequency signals in compliance with the user's command and performs impedance matching on the selected signal, thus enabling the multiple broadcast frequency signals to be received and processed by a single internal antenna and a single active module.

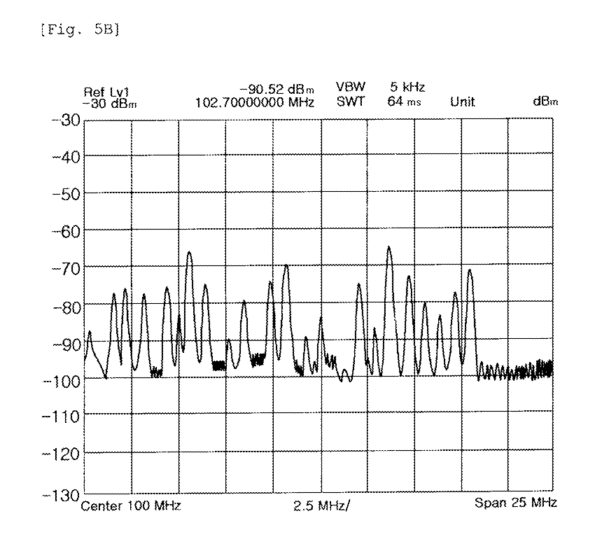

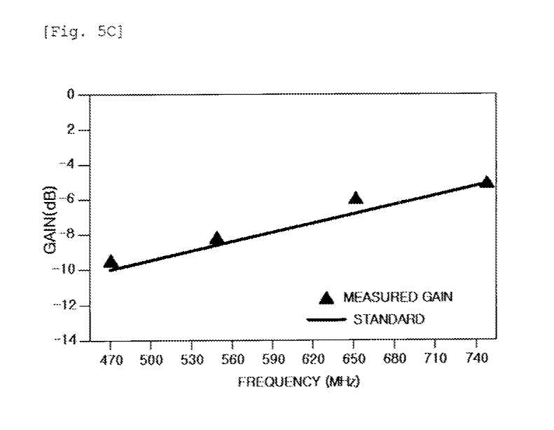

FIG. 5A is a graph showing an FM radio signal received by the internal antenna according to the present invention, and FIG. 5B is a graph showing an FM radio signal amplified while the FM radio signal of FIG. 5A passes through the first impedance matching unit of the active module. Referring to FIG. 5B, it can be seen that, when a weak FM radio signal is received together with a DVB-H signal by the internal antenna provided with a radiating element formed in a DVB-H pattern, the FM radio signal is amplified by the first impedance matching unit of the active module, thus enabling normal FM radio signals to be received.

FIG. 5C is a graph showing the gain of a DVB-H signal having passed through the active module according to the present invention. It can be seen through FIG. 5C that the gain of the DVB-H signal is improved through the active module.

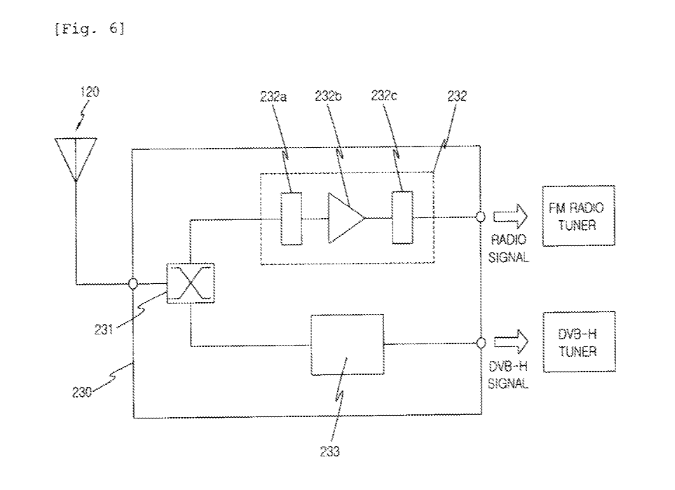

FIG. 6 is a diagram showing another embodiment of the active module of a modular active antenna for receiving multiple broadcast signals according to the present invention.

The embodiment of the active module of FIG. 6 according to the present invention has almost the same construction as the embodiment of the active module of FIG. 4, the only difference in that a diplexer 231 is provided instead of the switching unit 131. The diplexer 231 is operated by a control signal from the terminal control unit and is configured to separate input signals into a high-frequency band signal and a low-frequency band signal. Therefore, the diplexer 231 outputs a corresponding band signal among the multiple broadcast frequency signals received by the internal antenna 120 to either of the first impedance matching unit 232 or the second impedance matching unit 233 in response to a control signal.

The construction and operation of the active module of FIG. 6, except for the diplexer 231, are identical to those of the active module of FIG. 4, and thus a detailed description thereof is omitted.

Therefore, in the present invention, a single internal active antenna may receive two or more broadcast frequency signals and perform impedance matching, thus maximizing antenna efficiency.

As described above, the present invention is advantageous in that it receives multiple broadcast frequency signals using a single internal antenna and selectively performs impedance matching on the received multiple broadcast frequency signals using a single active module according to the frequency band, thus enabling the multiple broadcast frequency signals to be received by the single active antenna.

Further, the present invention is advantageous in that an internal antenna and an active module are implemented as one block-shaped module, thus improving the efficiency of the arrangement space of the antenna and increasing price competitiveness.

Although the preferred embodiments of the present invention have been disclosed for illustrative purposes, those skilled in the art will appreciate that the present invention may be implemented in various modifications without departing from the scope and spirit of the invention. The above embodiments are not intended to limit the present invention and are only intended to describe the present invention. Therefore, those skilled in the art will appreciate that various modifications, additions and substitutions are possible. Accordingly, the scope of the present invention should be defined by the technical spirit of the accompanying claims.

What is claimed is:

1. A modular active antenna for receiving multiple broadcast signals, comprising:
an internal antenna formed in a polyhedral shape having an open bottom surface and configured t, receive multiple broadcast frequency signals;
an active module arranged below the internal antenna to constitute a single module together with the internal antenna and configured to selectively perform impedance matching on any one of the multiple broadcast frequency signals received by the internal antenna; and
a printed circuit board configured to allow the internal antenna and the active module to be mounted thereon and provided with a ground surface formed on the bottom thereof.

2. The modular active antenna according to claim 1, wherein the internal antenna comprises:
a frame formed in a polyhedral shape having an open bottom surface;
a radiating element formed on a surface of the frame in a plurality of patterns for receiving the multiple broadcast frequency signals; and
a feed pin configured to connect the radiating element to the active module arranged below the frame.

3. The modular active antenna according to claim 1, wherein the active module comprises:
a switching unit for performing selective switching in response to a switching control signal so that a path for any one of the multiple broadcast frequency signals received by the internal antenna is established;
a first impedance matching unit for performing impedance matching on a first broadcast frequency signal among the multiple broadcast frequency signals switched by the switching unit; and
a second impedance matching unit for performing impedance matching on a second broadcast frequency signal among the multiple broadcast frequency signals switched by the switching unit.

4. The modular active module according to claim 3, wherein the first impedance matching unit comprises:
an input matching unit for performing input impedance matching on the first broadcast frequency signal output from the switching unit;
a low-noise amplifier for eliminating noise from the first broadcast frequency signal impedance-matched by the input matching unit and amplifying a noise-free first broadcast frequency signal; and
an output matching unit for performing output impedance matching on the first broadcast frequency signal amplified by the low-noise amplifier and outputting an impedance-matched first broadcast frequency signal.

5. The modular active antenna according to claim 1, wherein the active module comprises:
a diplexer for separating the multiple broadcast frequency signals received by the internal antenna into a high frequency band signal and a low frequency band signal in response to a switching control signal;
a first impedance matching unit for performing impedance matching on a first broadcast frequency signal, which is the low frequency band signal separated by the diplexer; and
a second impedance matching unit for performing impedance matching on a second broadcast frequency signal, which is the high frequency band signal separated by the diplexer.

6. The modular active module according to claim 5, wherein the first impedance matching unit comprises:
an input matching unit for performing input impedance matching on the first broadcast frequency signal output from the diplexer;
a low-noise amplifier for eliminating noise from the first broadcast frequency signal impedance-matched by the input matching unit and amplifying a noise-free first broadcast frequency signal; and
an output matching unit for performing output impedance matching on the first broadcast frequency signal amplified by the low-noise amplifier and outputting an impedance-matched first broadcast frequency signal.
